(19) United States
(12) Patent Application Publication
(10) Pub. No.: US 2026/0203058 A1
(43) Pub. Date: Jul. 16, 2026

(54) AI COMPUTATION DEVICE AND METHOD

(71) Applicant: MACRONIX INTERNATIONAL CO., LTD., Hsinchu (TW)

(72) Inventors: Cheng-Lin SUNG, Hsinchu County (TW); Hsiang-Lan LUNG, Kaohsiung City (TW)

(21) Appl. No.: 19/017,988

(22) Filed: Jan. 13, 2025

(51) Int. Cl. G06F 9/30; G06F 16/22

(52) U.S. Cl. CPC G06F 9/30036; G06F 16/2237

(57) ABSTRACT

A computation method and a computation device are disclosed. A vector similarity search is performed in the computational memory system based on a query input to identify a similar vector. The similar vector is transferred from the computational memory system to the GPU dedicated memory. The CPU provides an instruction to the GPU to perform an instruction processing operation. The GPU executes large language model computations to obtain a large language model computation result. The large language model computation result is transferred from the GPU back to the computational memory system.

### TECHNICAL FIELD

The disclosure relates to an artificial intelligence (AI) computation device and method thereof.

### BACKGROUND

Large Language Models (LLMs) are gaining increasing attention and applications. Generally, LLMs serve various purposes. When applied to natural language processing, LLMs can be used for: (1) Text generation: crafting articles, news reports, technical documents, or creative stories; (2) Language translation: efficiently and accurately translating between multiple languages; (3) Summary generation: extracting key information from lengthy content and producing concise summaries; and (4) Sentiment analysis: analyzing emotions in texts, such as in customer service or market analysis.

Moreover, LLMs can be utilized in intelligent assistants and customer service systems to provide instant responses, enhance user experience, and reduce the workload on human agents.

In education and academia, LLMs serve as auxiliary teaching tools, answering student queries or explaining knowledge. They also support academic research by assisting in literature search, data analysis, and knowledge discovery.

In healthcare, LLMs are being developed to help professionals analyze medical records, generate diagnostic reports, or support clinical decision-making.

Regarding information-related applications, LLMs enhance search engines and information retrieval by improving the relevance of search results and providing more accurate, context-aware answers.

LLMs can also be applied in content filtering and moderation, automatically detecting and removing inappropriate or non-compliant content, such as online comments or social media posts.

Despite their numerous applications, LLMs face several challenges. They require extensive GPU (Graphics Processing Units) and/or TPU (Tensor Processing Units) resources and energy for training and inference, leading to significant resource consumption. Furthermore, LLMs' high computational demands stem from their vast number of parameters, heavily relying on hardware resources like storage and flash memory. High training and deployment costs further limit their accessibility for small and medium-sized enterprises.

Specifically, in LLMs, vector database indexing and search play a crucial role in applications such as natural language processing, recommendation systems, medical diagnostics, and industrial manufacturing.

From a data security and local edge device perspective, businesses are increasingly inclined to store and process vector data on local edge devices rather than relying on centralized systems due to growing concerns about data security.

The demand for fully managed vector databases is rising significantly, driven by the need for large-scale storage, indexing, and search of unstructured data in an efficient manner.

Regarding trade-offs between integration and lightweight libraries, comprehensive vector databases should focus on optimal integration of hardware and software rather than depending on lightweight approximate nearest neighbor (ANN) search libraries.

LLMs also face challenges with large-scale vector datasets. For instance, the limited memory capacity of GPUs compared to main memory necessitates batch processing or chunk loading, reducing search efficiency. The substantial data transfers between GPU and main memory create performance bottlenecks. Compression algorithms, while improving storage and transmission efficiency, may affect search accuracy.

The industry requires innovative Al computing devices and methods to address the current challenges in LLM development.

### SUMMARY

According to one embodiment, a computation method for a computation device is provided. The computation method comprises: performing a vector similarity search in a computational memory system based on a query input to identify a similar vector; transferring the similar vector from the computational memory system to a Graphics Processing Unit (GPU) dedicated memory; providing an instruction from a Central Processing Unit (CPU) to the GPU to perform an instruction processing operation; executing large language model computations on the GPU to obtain a large language model computation result; and transferring the large language model computation result from the GPU back to the computational memory system.

According to another embodiment, a computation device is provided. The computation device comprises: a Central Processing Unit (CPU); a Graphics Processing Unit (GPU) coupled to the CPU; a GPU dedicated memory coupled to the GPU; and a computational memory system coupled to the GPU dedicated memory. A vector similarity search is performed in the computational memory system based on a query input to identify a similar vector. The similar vector is transferred from the computational memory system to the GPU dedicated memory. The CPU provides an instruction to the GPU to perform an instruction processing operation. The GPU executes large language model computations to obtain a large language model computation result. The large language model computation result is transferred from the GPU back to the computational memory system.

### BRIEF DESCRIPTION OF THE DRAWINGS

FIG. 1 illustrates a schematic diagram of a computational memory system according to an embodiment of the present disclosure.

FIG. 2 illustrates a functional block diagram of a computation device and a computation flowchart according to an embodiment of the present disclosure.

FIG. 3 shows the flowchart of generating text using a large language model.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

Technical terms of the disclosure are based on general definition in the technical field of the disclosure. If the disclosure describes or explains one or some terms, definition of the terms is based on the description or explanation of the disclosure. Each of the disclosed embodiments has one or more technical features. In possible implementation, one skilled person in the art would selectively implement part or all technical features of any embodiment of the disclosure or selectively combine part or all technical features of the embodiments of the disclosure.

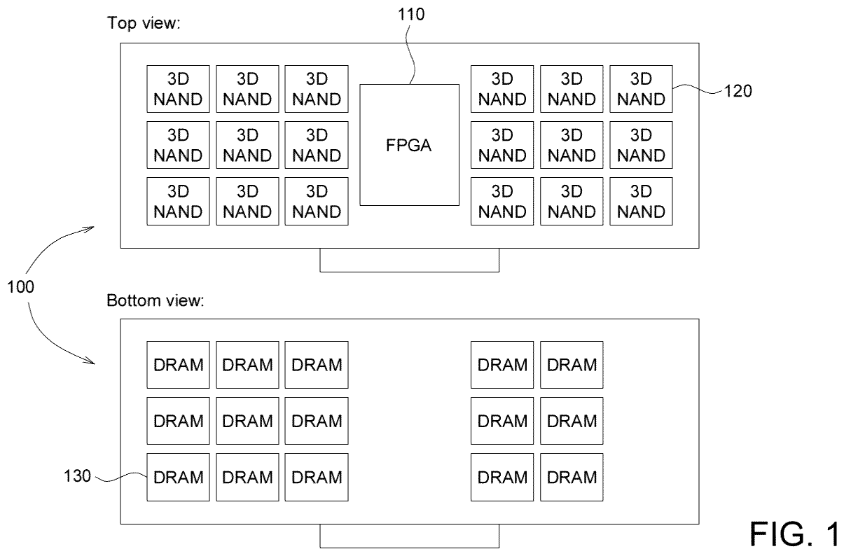

FIG. 1 illustrates a schematic diagram of a computational memory system according to an embodiment of the present disclosure. As shown in FIG. 1, the computational memory system 100 includes: a computational unit 110, multiple first memory modules 120, and multiple second memory modules 130. The computational unit 110 and the first memory modules 120 are located on one side of the computational memory system 100, while the second memory modules 130 are located on the opposite side of the computational memory system 100.

The computational unit 110 is coupled to and controls the first memory modules 120 and the second memory modules 130. The first memory modules 120 may be, for example, but are not limited to, three-dimensional (3D) NAND flash memory. The second memory modules 130 may be, for example, but are not limited to, dynamic random-access memory (DRAM).

The computational unit 110 performs multiple functions, such as vector search and memory control. The memory control functionality of the computational unit 110 includes managing data movement among the first memory modules 120, the second memory modules 130, and the GPU of a computational device (described later). The computational unit 110 may be, for example, but is not limited to, a Field-Programmable Gate Array (FPGA). The computational memory system 100 is designed with advanced storage and processing capabilities, integrating the computational unit 110 with the first memory modules 120 and the second memory modules 130 to optimize large-scale dataset processing. The first memory modules 120 are utilized as storage units to hold large datasets.

In one embodiment, the computational unit 110 plays a crucial role in data management and L2 computational tasks, significantly enhancing data processing efficiency.

In one embodiment, when the first memory modules 120 are implemented with 3D NAND technology, 3D NAND memories can store large volumes of vectors and embedding models, effectively reducing the dependence on the second memory modules 130 during CPU or GPU operations.

Furthermore, in this embodiment, optimization may be achieved by integrating 3D NAND with L2 computational tasks performed and driven by the computational unit 110. This minimizes data transfer latency, enabling faster and more efficient data processing.

Additionally, the computational memory system 100 employs non-volatile 3D NAND to store complete datasets, ensuring data reliability and durability.

Moreover, in other potential embodiments, emerging memory technologies may be selectively employed to address the speed gap between the storage units (first memory modules 120) and DRAM (second memory modules 130), bridging performance disparities and improving overall system efficiency.

The details of vector search execution by the computational unit 110 do not necessarily require specific limitations. For example but not limited by, vector search may involve techniques used in modern machine learning and artificial intelligence for efficient retrieval and matching of high-dimensional data. The core concept of vector search is to transform text, images, or other data into vectors and perform comparisons and retrievals within these vector spaces. The key steps of vector search are as follows. (1) Vectorization: Converting data (e.g., text, images, audio) into numerical vectors, where each dimension of the vector represents a semantic or feature of the data. (2) Index construction: For large datasets with millions or billions of vectors, direct search is costly, so index structures are built to accelerate the search process. (3) Similarity matching: For an input query vector, the system identifies the most similar vectors within the pre-built index.

The applications of vector search in LLMs include the follows. (1) Text retrieval: Transforming query text into vectors and searching for semantically similar content in databases or document collections. (2) Recommendation systems: Representing user behavior (e.g., clicks, purchases) or preferences as vectors and matching similar content for recommendations. (3) Knowledge-enhanced LLMs: In models like ChatGPT, vector search is used to incorporate external knowledge (e.g., enterprise documents) into model responses, improving accuracy and relevance. (4) Multimodal retrieval: Converting various types of data (e.g., images, text, video) into a shared vector space to enable cross-modal retrieval and matching.

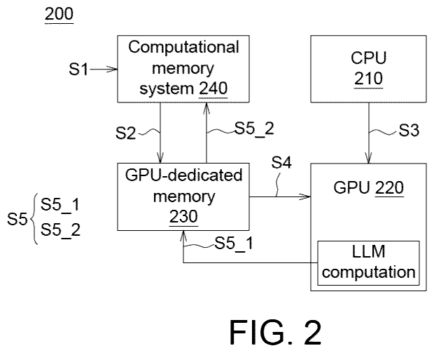

FIG. 2 illustrates a functional block diagram of a computation device and a computation flowchart according to an embodiment of the present disclosure. The computation device 200 includes: a CPU (Central Processing Unit) 210, a GPU (Graphics Processing Unit) 220, a GPU-dedicated memory 230, and a computational memory system 240. The computational memory system 240 can be implemented as the computational memory system 100 shown in FIG. 1.

The GPU 220 is coupled to the CPU 210 and the GPU-dedicated memory 230. The computational memory system 240 is coupled to the GPU-dedicated memory 230.

In step S1, a vector similarity search operation is performed by the computational memory system 240. For example, but not limited to, parallel vector similarity searches are executed in the computational memory system 240. In this step S1, based on the query input, the query input is converted into a query vector. The pre-constructed vector indexes stored in the first memory 120 are then used for similarity matching, searching for the most similar vectors to the query vector within the indexes.

In step S2, the most similar vectors found in step S1 are transferred from the computational memory system 240 to the GPU-dedicated memory 230. This step S2 ensures efficient transfer of similar vectors (identified in the similarity search) to the GPU-dedicated memory 230. Step S2 is crucial for optimizing memory usage and ensuring that GPU 220 can handle computations efficiently.

In step S3, instruction processing is performed. Specifically, the CPU 210 provides commands or instructions to the GPU 220 to initiate or manage processing tasks related to similarity searches and large language models (LLMs). During step S3, the CPU 210 configures the appropriate computational cores and data structures for the GPU 220. This step S3 involves setting up the computational tasks for the GPU 220, specifying the algorithms or operations to be executed, and establishing the parameters or configurations needed for instruction execution.

In step S4, all LLM computations are executed exclusively on the GPU 220 to produce the results of the large language model computations. In this embodiment, all tasks related to the LLM are carried out on GPU 220, leveraging its parallel processing capabilities to efficiently handle intensive computational tasks. LLM computations, for example, involve the GPU 220 executing machine learning models to analyze or generate outputs based on the identified similar vectors.

In step S5, the results of the LLM computations are copied back from the GPU 220 to the computational memory system 240. After completing the LLM computations, the results of the LLM computations are transferred from the GPU 220 back to the GPU-dedicated memory 230 (step S5_1) and then from the GPU-dedicated memory 230 to the computational memory system 240 (step S5_2). This step S5 is critical for retrieving and utilizing processed information. Step S5 ensures that the LLM computation results on the GPU 220 can be applied to broader use cases or analyses.

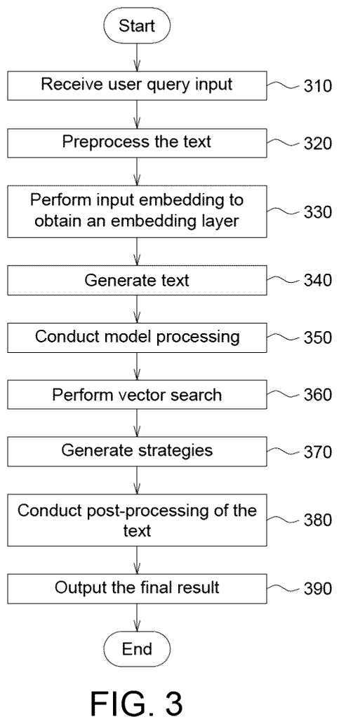

FIG. 3 shows the flowchart of generating text using a large language model. The flowchart of generating text includes: (1) Step 310: Receive user query input; (2) Step 320: Preprocess the text, including tokenization and encoding; (3) Step 330: Perform input embedding to obtain an embedding layer; (4) Step 340: Generate text, including decoding and generating a probability distribution; (5) Step 350: Conduct model processing, such as forward propagation, context modeling, and information retrieval; (6) Step 360: Perform vector search as shown in FIGS. 1 and 2; (7) Step 370: Generate strategies, including strategy selection and context generation; (8) Step 380: Conduct post-processing of the text; and (9) Step 390: Output the final result.

As described above, the invention employs FPGA-based computation for parallel vector similarity searches, improving search performance and enabling efficient vector similarity matching.

This invention integrates 3D NAND and DRAM to reduce data transfer latency and optimize memory utilization.

This invention uses 3D NAND to store large quantities of vectors and embedding models, reducing dependency on DRAM.

By combining 3D NAND with FPGA-driven L2 computation, this invention significantly reduces data transfer delays.

The invention utilizes non-volatile 3D NAND for persistent dataset storage, ensuring data security and stability.

This invention only transfers relevant vectors identified by the FPGA to the GPU, overcoming memory constraints and improving processing efficiency.

The above primarily described solutions provided by the embodiment of this invention from the perspective of vector search. It is understood that to achieve the aforementioned functionalities, the computation device 200 and/or the computational memory system 240 include corresponding hardware structures and/or software modules. A professional in the field can readily recognize that, combining the described elements and algorithmic steps, the invention can be implemented in hardware, software, or a combination thereof. The decision to execute functions via hardware or software depends on the specific application and design constraints. Different methods may be used to realize the described functionalities without departing from the scope of the invention.

In one embodiment, the computation device 200 and/or the computational memory system 240 can be functionally modularized based on the described methods. For example, each function may correspond to a separate module, or multiple functions may be integrated into a single processing module. The integrated module can be implemented as hardware or as a software module. It should be noted that the modular division in this embodiment is only an example and serves as a logical functional division. In practice, other methods of division may be used.

Although numerous specific details are described in this invention, they should not be understood as limiting the scope of the invention but rather as describing characteristics of specific embodiments. Certain features described in the context of a single embodiment may also be implemented in combination in a single embodiment. Conversely, various features described in the context of a single embodiment may be implemented individually or in appropriate sub-combinations across multiple embodiments.

While this disclosure has provided examples and implementations, it allows for changes, modifications, and enhancements within the disclosed content.

In conclusion, although the invention has been disclosed through these embodiments, it is not intended to limit the invention. Professionals in the field may make various changes and adjustments without departing from the spirit and scope of the invention. The scope of protection is defined by the attached claims.

1. A computation method for a computation device, the computation method comprising:
performing a vector similarity search in a computational memory system based on a query input to identify a similar vector;
transferring the similar vector from the computational memory system to a Graphics Processing Unit (GPU) dedicated memory;
providing an instruction from a Central Processing Unit (CPU) to the GPU to perform an instruction processing operation;
executing large language model computations on the GPU to obtain a large language model computation result; and
transferring the large language model computation result from the GPU back to the computational memory system.

2. The computation method according to claim 1, wherein
during the vector similarity search in the computational memory system, the query input is converted into a query vector; and
parallel similarity matching is performed on a plurality of pre-constructed vector indices stored in the computational memory system to identify the similar vector from the pre-constructed vector indices.

3. The computation method according to claim 1, wherein
during the instruction processing operation, the CPU provides the instruction to the GPU to initiate or manage processing tasks related to similarity searches and large language models (LLM); and
the CPU configures a computational core and a data structure for the GPU, sets a computational task for the GPU, specifies an algorithm, and constructs required parameters.

4. The computation method according to claim 1, wherein
during the large language model computations, the GPU executes a machine learning model based on the similar vector to analyze or generate the large language model computation result.

5. The computation method according to claim 1, wherein
the large language model computation result is transferred from the GPU to the GPU-dedicated memory, and then from the GPU-dedicated memory to the computational memory system.

6. A computation device comprising:
a Central Processing Unit (CPU);
a Graphics Processing Unit (GPU) coupled to the CPU;
a GPU dedicated memory coupled to the GPU; and
a computational memory system coupled to the GPU dedicated memory,
wherein
a vector similarity search is performed in the computational memory system based on a query input to identify a similar vector;
the similar vector is transferred from the computational memory system to the GPU dedicated memory;
the CPU provides an instruction to the GPU to perform an instruction processing operation;
the GPU executes large language model computations to obtain a large language model computation result; and
the large language model computation result is transferred from the GPU back to the computational memory system.

7. The computation device according to claim 6, wherein
during the vector similarity search in the computational memory system, the query input is converted into a query vector; and
parallel similarity matching is performed on a plurality of pre-constructed vector indices stored in the computational memory system to identify the similar vector from the pre-constructed vector indices.

8. The computation device according to claim 6, wherein
during the instruction processing operation, the CPU provides the instruction to the GPU to initiate or manage processing tasks related to similarity searches and large language models (LLM); and
the CPU configures a computational core and a data structure for the GPU, sets a computational task for the GPU, specifies an algorithm, and constructs required parameters.

9. The computation device according to claim 6, wherein
during the large language model computations, the GPU executes a machine learning model based on the similar vector to analyze or generate the large language model computation result.

10. The computation device according to claim 6, wherein
the large language model computation result is transferred from the GPU to the GPU-dedicated memory, and then from the GPU-dedicated memory to the computational memory system.

11. The computation device according to claim 6, wherein the computational memory system includes:
a plurality of first memory modules;
a plurality of second memory modules; and
a computational unit coupled to and controlling the first memory modules and the second memory modules,
the computational unit and the first memory modules are located on one side of the computational memory system, while the second memory modules are located on an opposite side of the computational memory system; and
the computational unit performs vector search and memory control.
